(19) United States
(12) Patent Application Publication
(10) Pub. No.: US 2025/0326341 A1
(43) Pub. Date: Oct. 23, 2025

(54) OPERATOR SEAT

(71) Applicant: DEERE & COMPANY, MOLINE, IL (US)

(72) Inventors: BRIAN M. HUENINK, CEDAR GROVE, WI (US); MICHAEL W. THOMPSON, CLAYTON, IN (US); ANDREJ CILING, MARTIN (SK)

(21) Appl. No.: 18/639,057

(22) Filed: Apr. 18, 2024

(51) Int. Cl. B60N 2/38; B60N 2/14; B60R 11/00; B60R 11/02

(52) U.S. Cl. CPC B60N 2/38; B60N 2/14; B60R 11/0229; B60R 11/0241; B60R 2011/0014

(57) ABSTRACT

An operator seat of a work vehicle positioned in a cab includes a stationary seat portion, a moveable seat portion, a holder, and an actuator. The moveable seat portion is swivelable relative to the stationary seat portion around a swivel axis. The holder is used to secure an electronic device. The support is connected to the holder. The holder is pivotable relative to the support between a view position and a folded position. The actuator is coupled to the holder and is actuated, in response to a relative motion between the stationary seat portion and the moveable seat portion, to pivot the holder between the view position and the folded position.

### TECHNICAL FIELD

The present disclosure relates generally to a vehicle, in particular to a seat of a work vehicle.

### BACKGROUND

A vehicle, such as a work vehicle, normally provides a seat for an operator to operate the vehicle. The operator may swivel the seat to observe different zone outside the vehicle. Several electronic devices, such as a display, may be coupled to one or more components, such as a command arm, of the seat which extends away from a backrest of the seat.

### SUMMARY

According to a disclosure, an operator seat of a work vehicle positioned in a cab includes a stationary seat portion, a moveable seat portion, a holder, and an actuator. The moveable seat portion is swivelable relative to the stationary seat portion around a swivel axis. The holder is used to secure an electronic device. The support is connected to the holder. The holder is pivotable relative to the support between a view position and a folded position. The actuator is coupled to the holder and is actuated, in response to a relative motion between the stationary seat portion and the moveable seat portion, to pivot the holder between the view position and the folded position.

In one aspect of the disclosure, the actuator includes a linkage and a cable. One end of the cable is coupled to the linkage, and the other end of the cable is coupled to the holder.

In one aspect of the disclosure, the operator seat has a first arm pivotably coupled to the moveable seat portion around a pivot axis and extending forward. The holder is coupled to the first arm.

In one aspect of the disclosure, the actuator includes a linkage coupled between the first arm and the moveable seat portion.

In one aspect of the disclosure, the linkage includes a bell crank having a first lever, a second lever, and a pivot point extending the first lever and the second lever. A distal end of the first lever is coupled to one end of a cable. The other end of the cable is coupled to the holder. The distal end of the second lever is coupled to one of the first arm and the moveable seat portion. The pivot point is coupled to the other one of the first arm. The moveable seat portion and is pivotable in response to an angle change between the first arm and the moveable seat portion translated from the relative motion between the stationary seat portion and the moveable seat portion.

In one aspect of the disclosure, the linkage includes a connecting link having one end pivotably connected to one of the first arm and the moveable seat portion and an elongate slot forming adjacent to the other end of the connecting link. The distal end of the second lever includes a protrusion moveably engaging with the elongate slot in response to the angle change.

In one aspect of the disclosure, the operator seat includes a strut connected to the first arm at one end and having a cam at the other end. The stationary seat portion includes a guide along which the cam is slidably engaged to selectively pivot the first arm inward relative to the moveable seat portion or away from the moveable seat portion, in response to the relative motion between the stationary seat portion and the moveable seat portion.

In one aspect of the disclosure, when the first arm is pivoted inward relative to the moveable seat portion, the linkage is driven by a movement therebetween to pivot the holder from the view position to the folded position.

In one aspect of the disclosure, the linkage includes a bell crank having a first lever, a second lever, and a pivot point extending the first lever and the second lever and coupled to the first arm. The linkage also includes a connecting link pivotably coupled to the moveable seat portion. A distal end of the first lever is coupled to one end of a cable. The other end of the cable is coupled to the holder. A distal end of the second lever is coupled to the connecting link. The pivot point is pivotable in response to an angle decreasing, between the first arm and the moveable seat portion, translated from the relative motion between the stationary seat portion and the moveable seat portion.

In one aspect of the disclosure, the swivel axis defines a swivel center on the stationary seat portion. The guide is eccentric and includes a forward portion and a rearward portion. A radial distance between the forward portion and the swivel center is longer than a radial distance between the rearward portion and the swivel center.

In one aspect of the disclosure, the support is coupled to the holder via a joint having a torsion spring to provide a breakaway feature between the view position and the folded position.

In one aspect of the disclosure, the operator seat includes a post extending from the first arm and connected to or included by the support and a display installed on the post adjacent to the holder.

In one aspect of the disclosure, the swivel axis and the pivot axis are parallel to each other.

In one aspect of the disclosure, the operator seat includes a first arm and a second arm. The first arm is coupled to the moveable seat portion around and extending forward. The holder is coupled to the first arm. The second arm is coupled to the moveable seat portion and extending forward. The second arm is disposed opposite the first arm across the moveable seat portion.

In one aspect of the disclosure, the operator seat includes a second strut connected to the second arm at one end and having a cam at the other end. The stationary seat portion includes a second guide along which the cam is slidably engaged.

In one aspect of the disclosure, the second strut is connected to the second arm with a shaft extending from the one end of the second strut. The actuator includes a linkage coupled to the shaft and a cable. One end of the cable is coupled to the linkage and the other end of the cable is coupled to the holder. When the cam of the second strut moves along the second guide in response to the relative motion between the stationary seat portion and the moveable seat portion, the second strut with the shaft rotates relative to the moveable seat portion to pull the cable to pivot the holder.

In one aspect of the disclosure, the operator seat includes an attachment mounted on the moveable seat portion, pivotable coupled to the shaft, and configured to hold a conduit of the cable near the one end of the cable.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a simplified side view of an example work vehicle in the form of a tractor.

FIG. 2 is a top front perspective view of a cab interior of the work vehicle of FIG. 1.

FIG. 3 is an operator's perspective view when the operator sits on an operator seat.

FIG. 4A is a front view of a first arm of the operator seat, a holder, a support, an actuator, and a display.

FIG. 4B is a rear view of the first arm of the operator seat, the holder, the support, the actuator, and the display.

FIG. 4C is an exploded view of the holder and the support.

FIG. 4D is a top view of the holder and the support when the holder is at a view position.

FIG. 4E is a top view of the holder and the support when the holder is at a folded position.

FIG. 4F is a bottom view of the holder and the support when the holder is at a view position.

FIG. 4G is a bottom view of the holder and the support when the holder is at a folded position.

FIG. 5A is a top view of a stationary seat portion and a moveable seat portion when the relative position thereof is a neutral position.

FIG. 5B is a bottom view of the stationary seat portion, the moveable seat portion, and an actuator of a first implementation, when the relative position of the stationary seat portion and the moveable seat is the neutral position.

FIG. 5C is a rear perspective view of the stationary seat portion and an actuator of a second implementation, when the relative position of the stationary seat portion and the moveable seat is the neutral position.

FIG. 5D is a rear bottom perspective view of the stationary seat portion, the moveable seat portion, and the actuator of the first implementation, when the relative position of the stationary seat portion and the moveable seat is left swivel position.

FIG. 6A is a top view of the stationary seat portion and the moveable seat portion when the relative position thereof is a left swivel position.

FIG. 6B is a bottom view of the stationary seat portion, the moveable seat portion, and the actuator of the first implementation, when the relative position of the stationary seat portion and the moveable seat is the left swivel position.

FIG. 6C is a rear perspective view of the stationary seat portion and the actuator of the second implementation, when the relative position of the stationary seat portion and the moveable seat is the left swivel position.

FIG. 7A is a top view of the stationary seat portion and the moveable seat portion when the relative position thereof is a right swivel position.

FIG. 7B is a bottom view of the stationary seat portion, the moveable seat portion, and the actuator of the first implementation, when the relative position of the stationary seat portion and the moveable seat is the right swivel position.

FIG. 7C is a rear perspective view of the stationary seat portion and the actuator of the second implementation, when the relative position of the stationary seat portion and the moveable seat is the right swivel position.

Like reference numerals are used to indicate like elements throughout the several figures.

### DETAILED DESCRIPTION

Present disclosure demonstrates an electronic device holder included by or coupled to the operator seat of a work vehicle. The operator seat is positioned within a cab of the work vehicle. The electronic device holder, with an electronic device such as a smartphone or other portable electronic device, is coupled to an arm extending forward from the operator seat with a proper distance from the operator. The operator may swivel the seat to observe different zone outside the vehicle. During the rotation of the operator seat, the holder and the electronic device held by the holder rotate together with the operator seat. Due to limited internal space in the cab, the movement of the holder and the electronic device may hit the wall of the cab. The present disclosure includes various structures and implementations allowing the holder to pivot between a view position and a folded position to avoid potential damages on the holder and the electronic device and to clear the upholstery. However, other variations and modifications may be made without departing from the scope and spirit of the present disclosure.

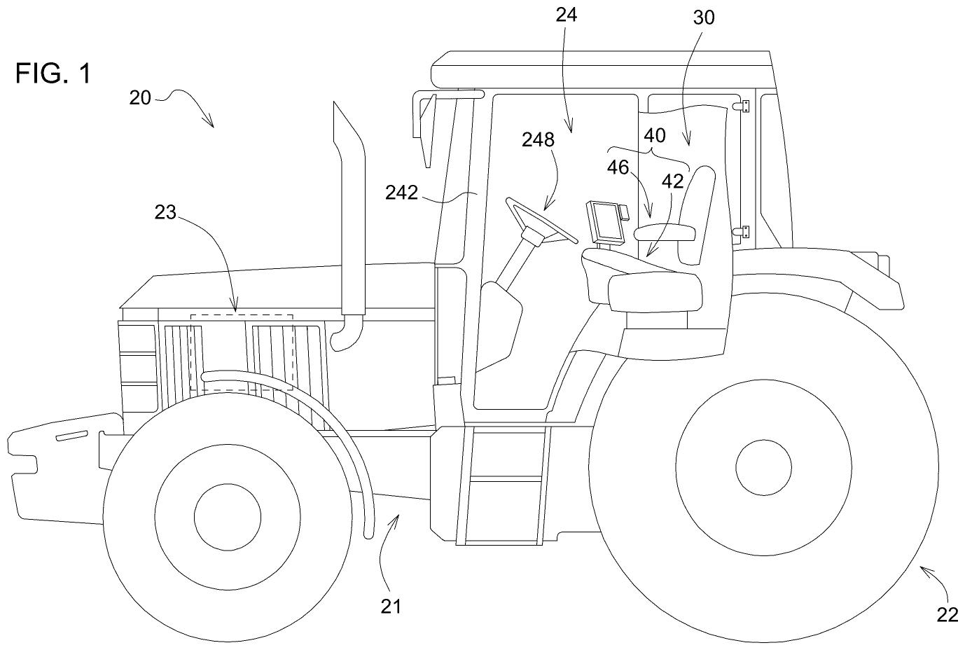

Referring to FIG. 1, a vehicle, embodied as a tractor 20, normally includes a mainframe 21, a ground engaging device 22, a power source 23, and a cab 24. The mainframe 21 is supported by the ground engaging device 22, which may be wheels, tracts, or other devices. The ground engaging device 22 engages the ground and is driven by the power source 23 to propel the tractor 20. The mainframe 21 may carry the power source 23, which may be a combustion engine or battery packs and motor(s). It is noted that other drivetrain components or electric vehicle components, includes but are not limited to transmissions, axles, differentials, hydraulic pumps, inverters, are omitted in FIG. 1. The mainframe 21 also supports the cab 24. Referring to FIGS. 1-3, the cab 24 provides an environment for the operator to sit and control the tractor 20. The cab 24 may include cab frame structure 242, a wall 244, a floor 246, and a steering wheel 248. The wall(s) 244 and floor 246 may be installed on the cab frame structure 242. An operator seat 30 may be positioned on the floor 246. The wall 244 may include safety glass and/or panel (not shown), defining a cab interior. The steering wheel 28 extends from the front of the cab 24 toward the operator seat 30.

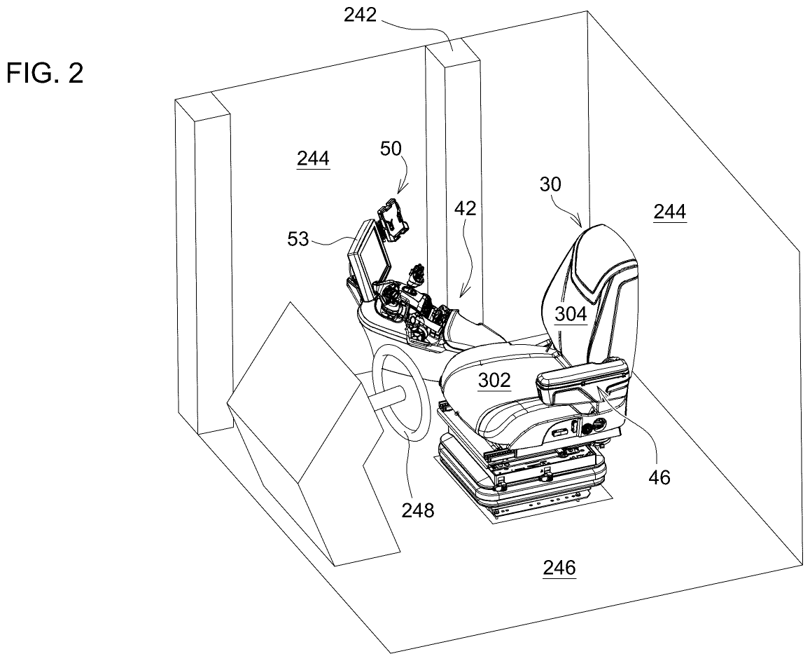

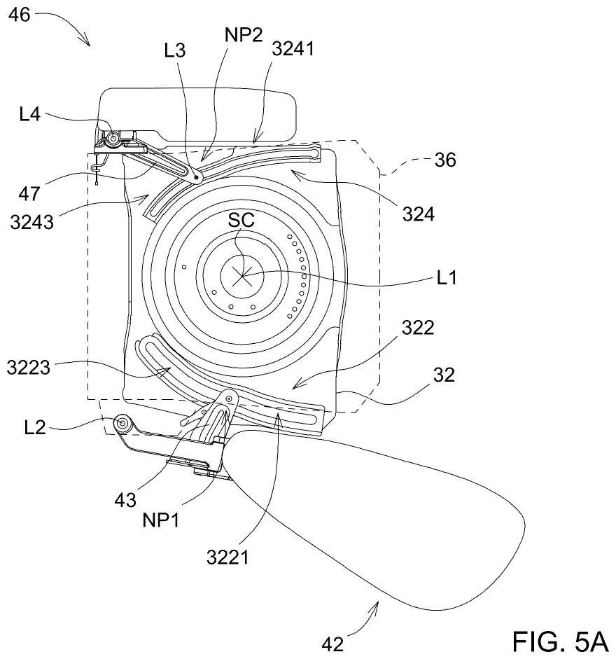

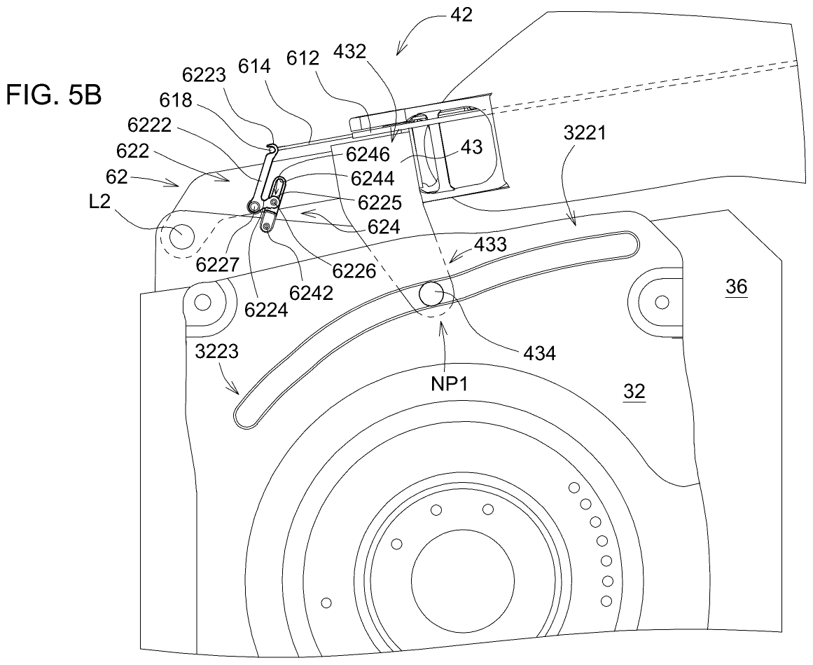

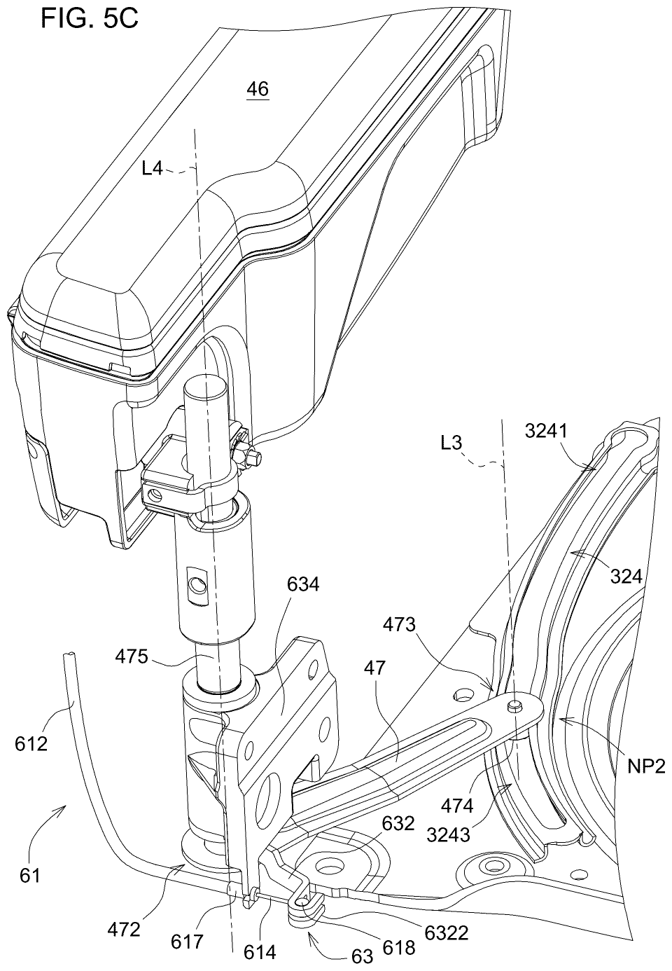

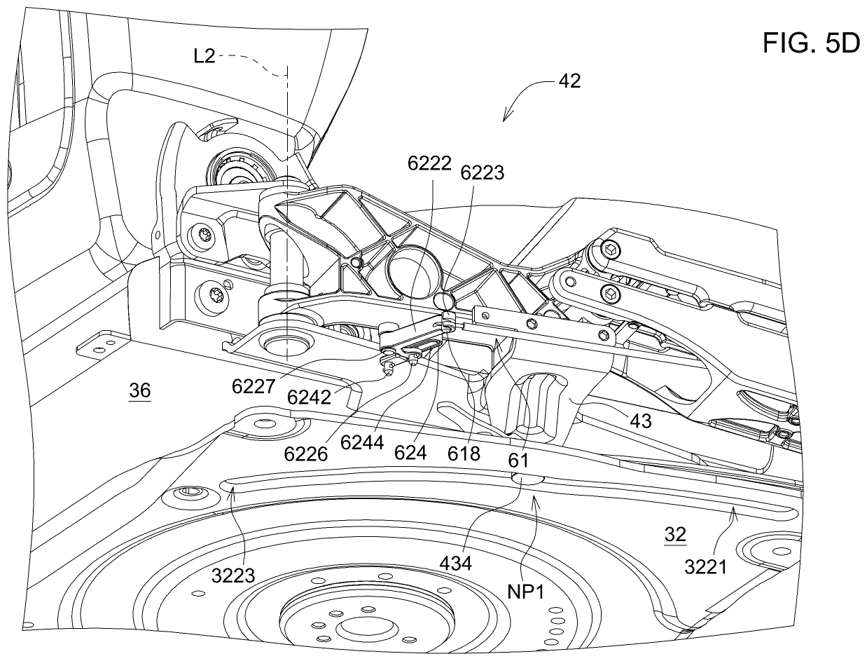

The operator seat 30 includes a seat base 302 and a backrest 304. The seat base 302 has a cushion for the operator to sit. The seat base 302 is a part of a moveable seat portion 36 swivelable relative to a stationary seat portion 32 around a swivel axis L1, as shown in FIGS. 5A, 6A, 7A. The swivel axis L1 defines a swivel center SC on the stationary seat portion 32. The stationary seat portion 32 is not swivelable relative to the floor 246 of the cab 24. The stationary seat portion 32 may include a metal swivel base. The stationary seat portion 32 may be coupled to other component of the operator seat 30, such as tracks on the floor 246 of the cab 24. Thus, the operator seat 30 is moveable between a forward position and a backward position on the floor 246. The details of the stationary seat portion 32 and the moveable seat portion 36 will be described later. Referring to FIGS. 1-3, the backrest 304 is coupled to the seat base 302 and may be reclinable relative to the seat base 302. The backrest 304 has a cushion which the operator can lean against. The operator seat 30 may also include an arm assembly 40 having a first arm 42 and a second arm 46, which are respectively coupled to the sides of the moveable seat portion 36, as shown in FIGS. 5A, 6A, 7A. Referring to FIG. 2, in this example, the first arm 42 is a command arm, equipped with multiple input devices, including but not limited to a display 53, physical buttons, joysticks, and microphones for the operator to control the tractor 20. The second arm 46 is a rest arm and may allow the operator to place his or her arm for rest. As shown in FIGS. 1-3, the first arm 42 is the right arm of the operator seat 30 and the second arm 46 is the left arm of the operator seat 30. In another embodiment, the first arm 42 can be the left arm of the operator seat 30 and the second arm 46 can be the right arm of the operator seat 30 (not shown). In another embodiment, the first arm 42 and second arm 46 are both command arms or rest arms.

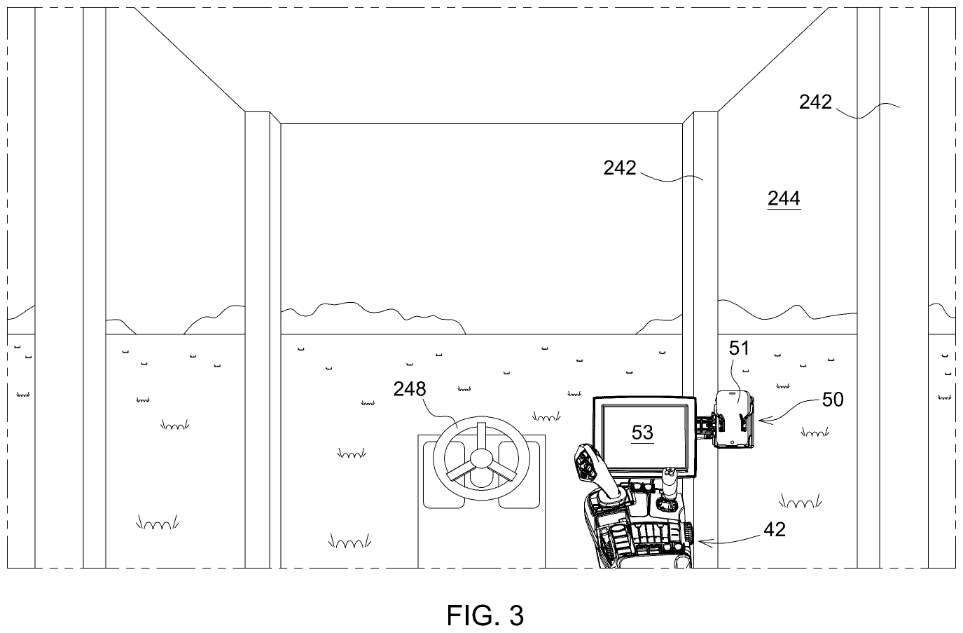

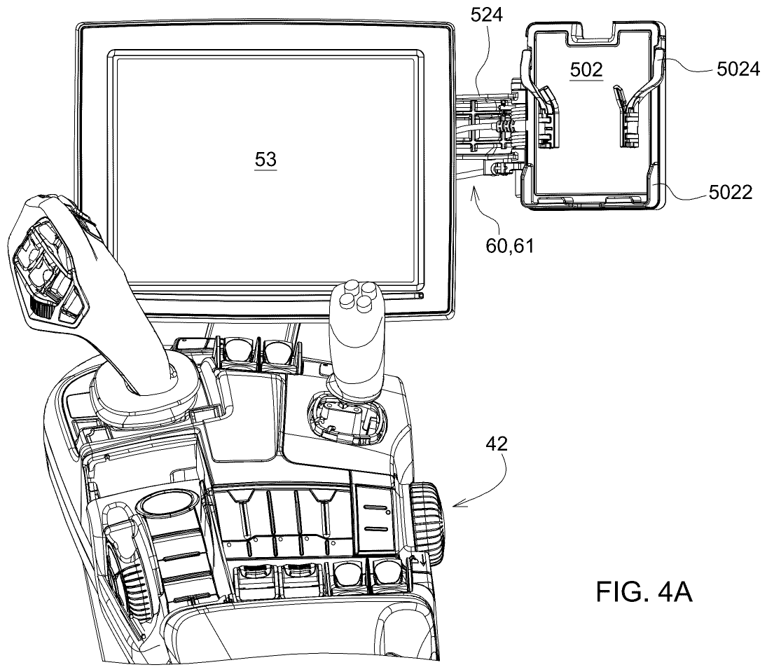

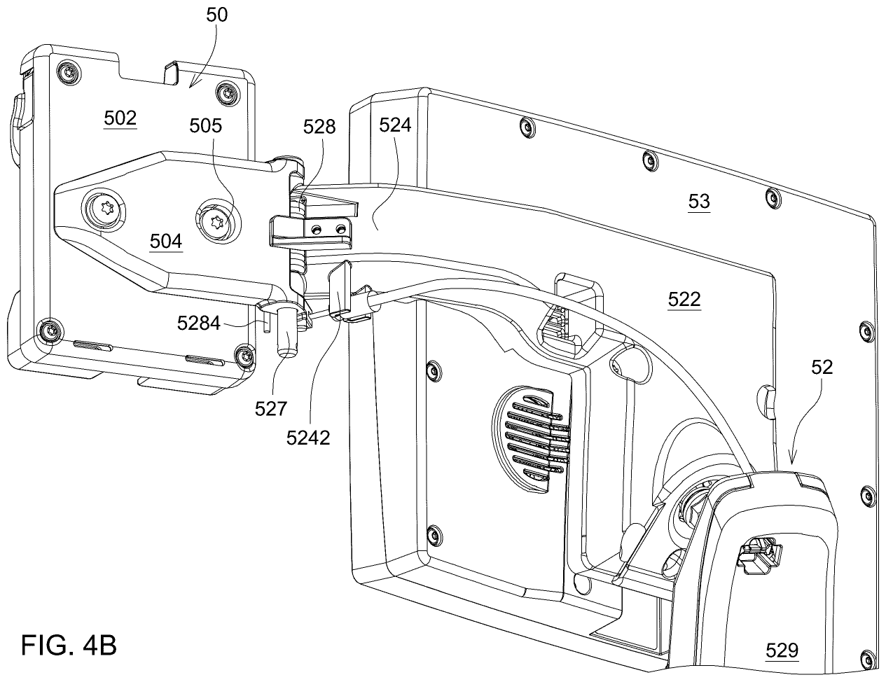

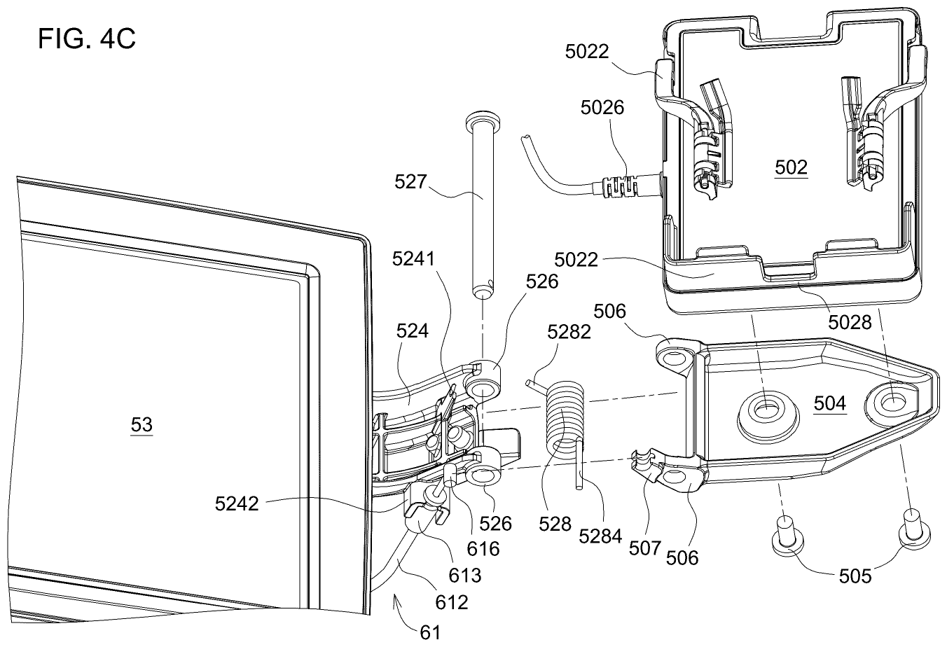

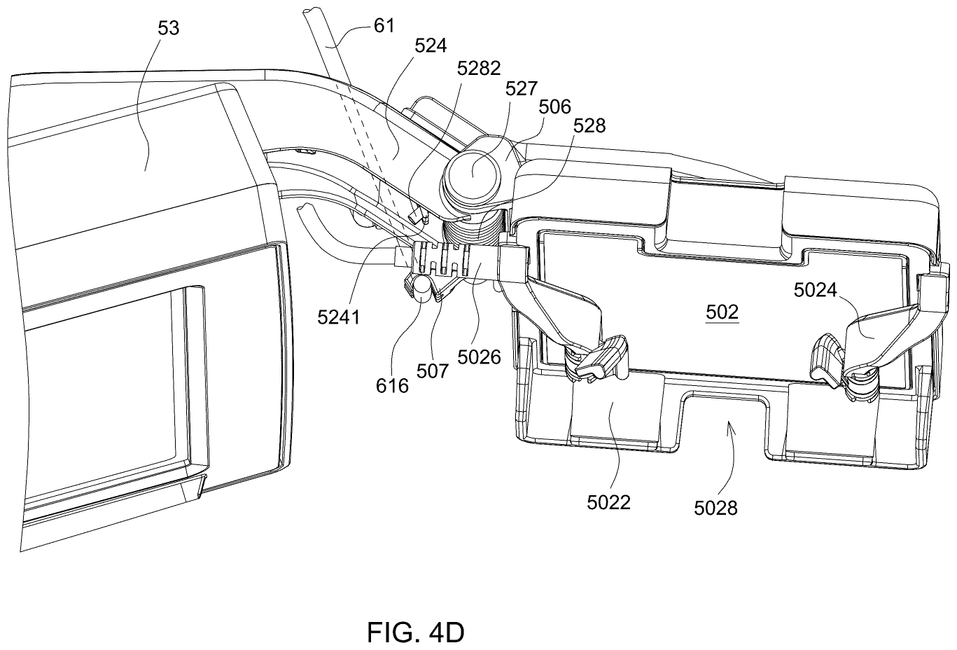

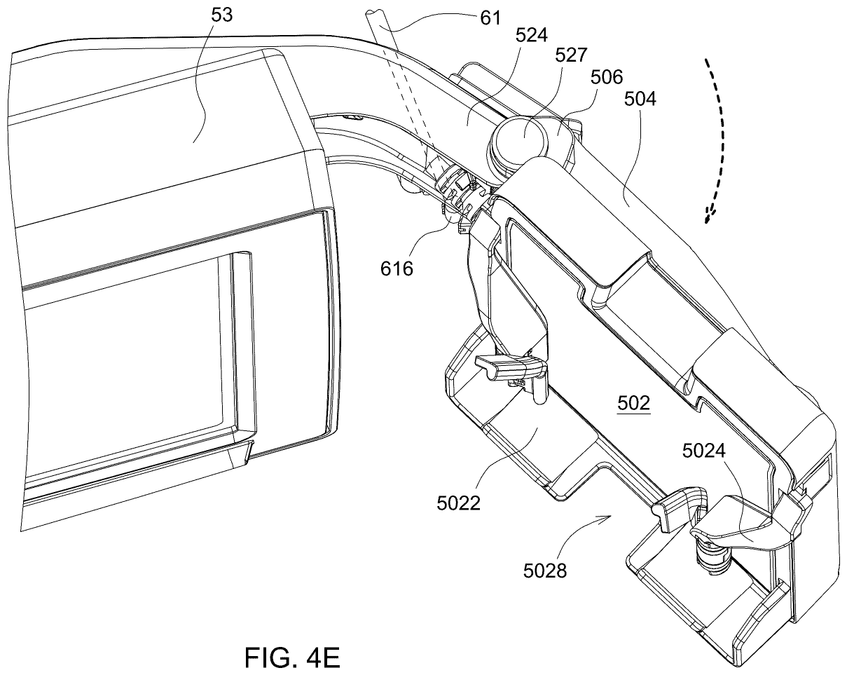

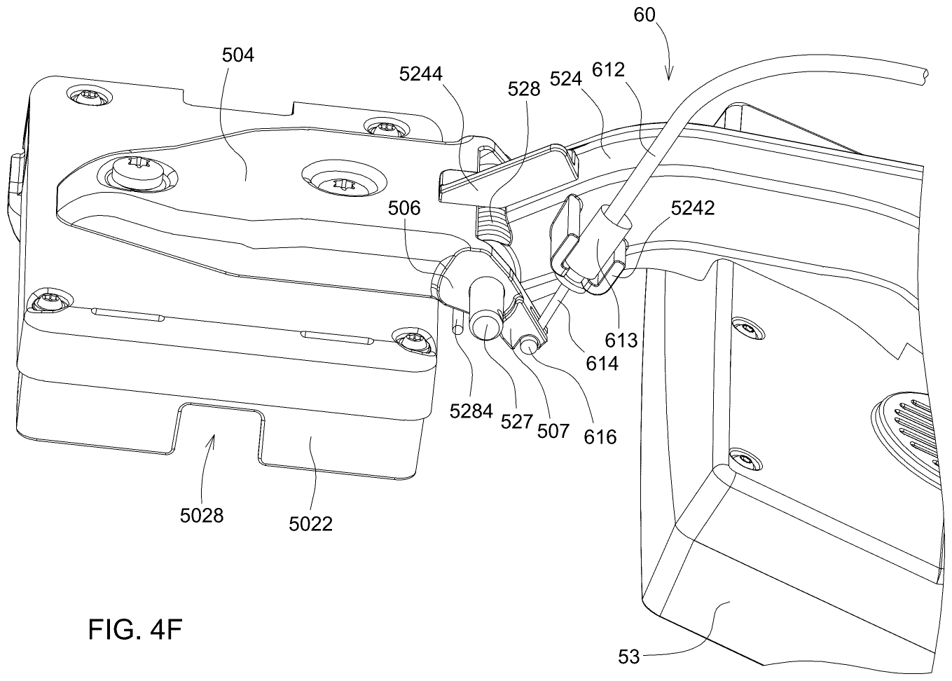

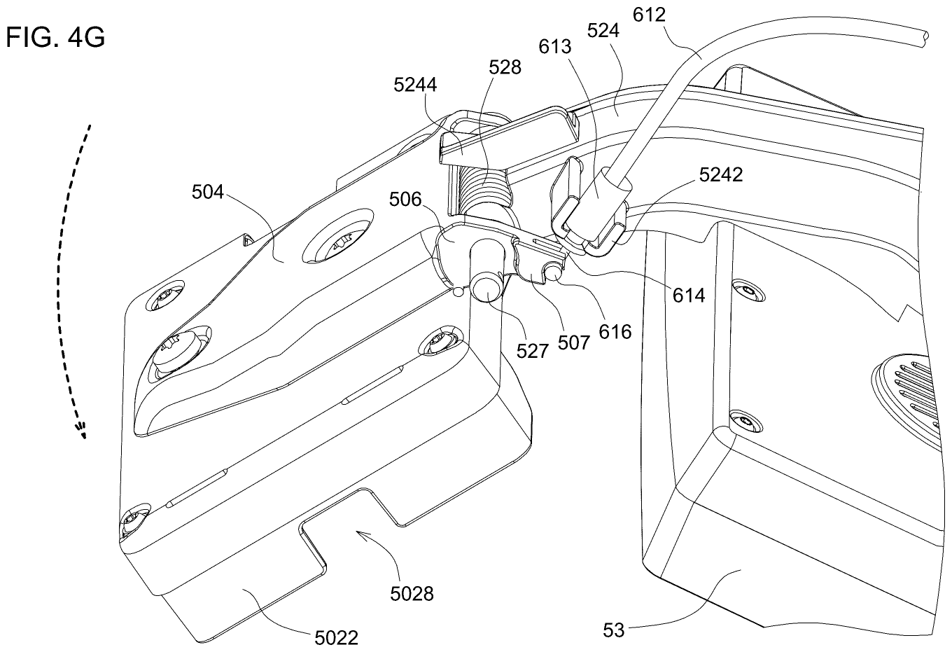

With reference to FIG. 3, the operator seat 30 may have a holder 50 used to hold an electronic device 51, including but not limited to a smartphone. In order to demonstrate the structure of the holder 50 and other components, the electronic device 51 is omitted in FIGS. 4A-4G. The operator seat 30 may have a support 52 to support the display 53 and the holder 50. The support 52 is connected to the holder 50, and the holder 50 is pivotable relative to the support 52 between a view position (FIGS. 4A, 4B, 4D, 4F) and a folded position (FIGS. 4E, 4G). The view position is a position of the holder 50 and the electronic device 51 comfortable for the operator to watch the screen of the electronic device 51. The folded position is a position where the holder 50 is pivoted inward to avoid the holder 50 and the electronic device 51 hitting on the cab frame structure 242 and the wall 244. The holder 50 may include a body 502 and an attachment 504 attached to the body 502 via fasteners 505 (FIGS. 4B, 4C). The body 502 may extend a retaining piece 5022 from the bottom edge and lower side edges. The retaining piece 5022 may carry the weight of the electronic device 51 and prevent lateral movement of the electronic device 51 relative to the body 502. The body 502 may further includes two securing elements 5024 to selectively secure the electronic device 51 at the holder 50. The body 502 may include or connect a cord 5026. The cord 5026 in this example is a charging cord and provides power from a power unit (not shown) of the tractor 20 to a power transmitter (not shown) disposed in the body 502. In another example, which is not shown, the body 502 may include a port for a transmission cord electrically coupled to the cord 5026 and to the electronic device 51 for power and/or data transmission. The body 502 may have notch 5028 or hole, corresponding to a port of the electronic device 51, such that the transmission cord or other type of cord can connect the port of the electronic device 51. An edge of the attachment 504 near the support 52 includes two tabs 506 spaced apart and extending toward the support 52.

The support 52 may include a body 522, an extension 524, two tabs 526, a pin 527, a spring 528, and a post 529. The post 529 may extend upward from a forward distal portion of the first arm 42. The body 522 of the support 52 and the post 529 may be connected via a ball joint or other types or joint. The display 53 is mounted on the body 522 of the support 52. As shown in FIG. 4B, the body 522 of the support 52 extends laterally to form the extension 524. An edge of the extension 524 near holder 50 includes two tabs 526 spaced apart and extending toward the holder 50. The tabs 526 of the extension 524 are both positioned between the tabs 506 of the attachment 504. A coil of the spring 528 is positioned between the tabs 526 of the extension 524. The holes of the tabs 526 and the holes of the tabs 506, and the coil of the spring 528 are aligned for the pin 527 passing through to form a joint. The spring 528 may extends a leg 5282 and a leg 5284 from the coil of the spring 528. The spring 528 in this example is a torsion spring. The leg 5282 may press the extension 524 at a receiver 5241 (shown in FIGS. 4C,4D) and the leg 5284 may press at an edge of one of the tab 506 (shown in FIGS. 4F, 4G). When the holder 50 is pivoted from the view position to the folded position by an actuator 60 and then the moveable seat portion 36 returns the neutral position, which is described later, the spring force of the spring 528 will return the holder 50 to the view position. The spring 528 is also used to provide a breakaway feature between the view position (FIGS. 4A, 4B, 4D, 4F) and the folded position (FIGS. 4E, 4G) of the holder 50. The breakaway feature may lessen a potential damage of the holder 50 and the electronic device 51 caused by hitting the cab frame structure 242 and/or the wall 244, when the moveable seat portion 36 swivels to the right. The breakaway feature allows the reaction from the cab frame structure 242 and/or the wall 244 to pivot the holder 50 from the view position toward the folded position. As shown in FIGS. 4F, 4G, a stop 5244 is positioned outside of the extension 524 and near the attachment 504 of the holder 50. When the holder 50 is at the view position, as shown in FIG. 4F, the spring force from the spring 528 may abut the attachment 504 of the holder 50 against the stop 5244. The stop 5244 may prevent the excessive spring force from pivoting the holder 50 beyond the view position. When the holder 50 is at the folded position, as shown in FIG. 4F, the holder 50 is away from the stop 5244.

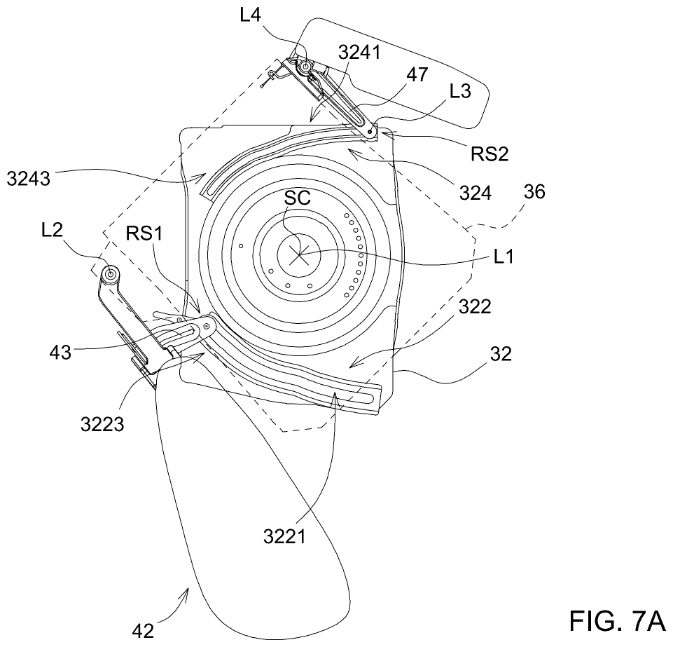

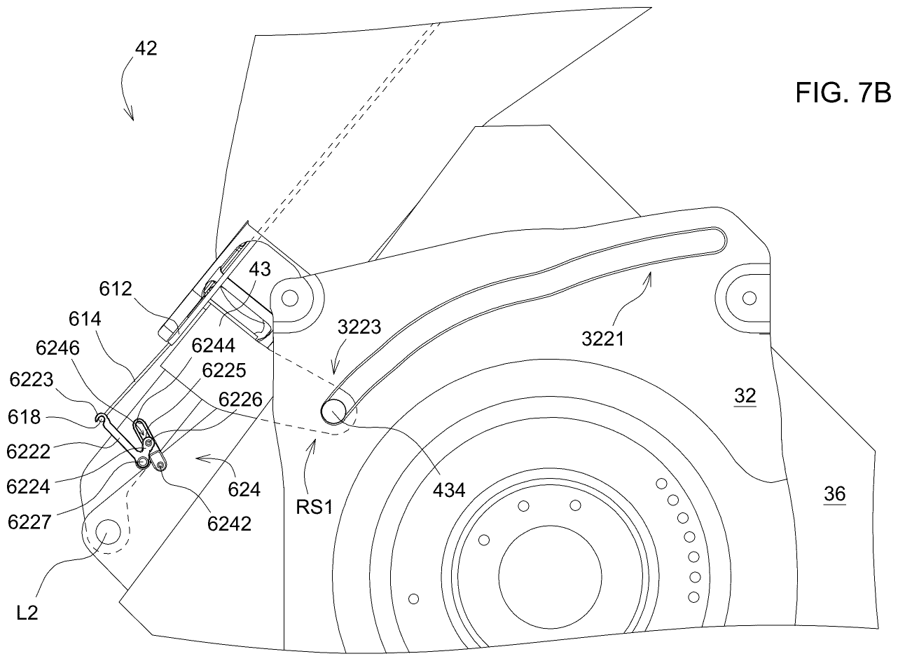

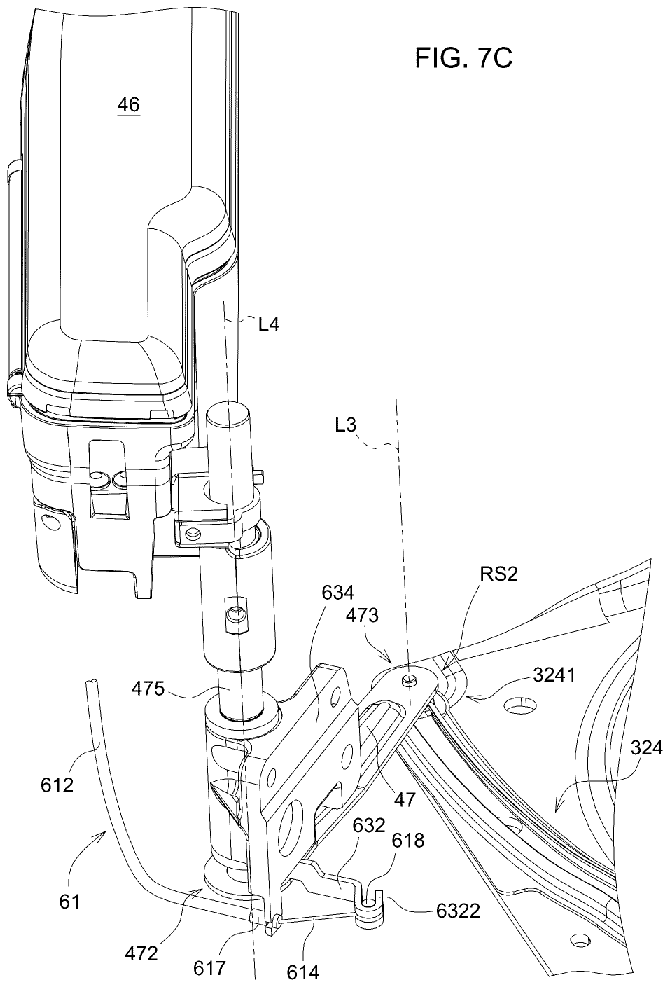

Alternatively or additionally, instead of the reaction, the force from the actuator 60 may pivot the holder 50 from the view position toward the folded position. The operator seat 30 may include the actuator 60 (FIG. 4A, for example) coupled to the holder 50 and actuated, in response to a relative motion between the stationary seat portion 32 and the moveable seat portion 36, to pivot the holder 50 between the view position and the folded position. Referring to FIGS. 4B-4G, the actuator 60 includes a cable 61, which is in the form of a pull cable. The cable 61 may have a conduit 612, a terminal 613 (optional) at one end of the conduit 612, and a core wire 614 partially covered by the conduit 612. The extension 524 of the support 52 has a conduit holder 5242 used to receive and hold the terminal 613 (or the end of the conduit 612). The core wire 614 of the cable 61 include a first end 616 (FIGS. 4B-4G) in the form of a pillar shape. Referring to FIGS. 4F, 4G, the first end 616 of the cable 61 is coupled to a connector 507 of one tab 506 of the holder 50. When the holder 50 is at the view position, a length of the core wire 614 is exposed outside of the conduit 612, as shown in FIG. 4F. When the holder 50 is at the folded position, a length of the core wire 614 exposed outside of the conduit 612, as shown in FIG. 4G, becomes shorter. That is, a portion of the core wire 614 outside of the terminal 613 of the conduit 612 is pulled back into the conduit 612, with the conduit holder 5242 securing the position of the terminal 613, and the other end (i.e., a second end 618 shown in FIG. 7B or 7C) of the core wire 614 of the cable 61 is pulled and a length of the core wire 614 outside of a terminal 617 (or the other end of the conduit 612) becomes longer. With the pull from the core wire 614 of the cable 61, the holder 50 is pivoted from the view position to the folded position. The present disclosure includes various structures and implementations of actuators (such as a linkage 62 in FIG. 5B and a linkage 63 in FIG. 5C) of the actuator 60 to pull the second end 618 of the core wire 614 of the cable 61. However, other variations and modifications may be made without departing from the scope and spirit of the present disclosure.

FIGS. 5A, 6A, 7A are top views of the stationary seat portion 32 and the moveable seat portion 36 when the relative positions thereof are a neutral position, a left swivel position, and a right swivel position. Although the moveable seat portion 36 may be positioned above the stationary seat portion 32, for the clarity of the structure of the stationary seat portion 32, the moveable seat portion 36 is illustrated in a dashed line. FIGS. 5B, 6B, 7B are bottom views of the stationary seat portion 32, the moveable seat portion 36, and the actuator 60 of a first implementation, when the relative positions between stationary seat portion 32 and the moveable seat portion 36 are the neutral position, the left swivel position, and the right swivel position. FIGS. 50, 60, 7C are rear perspective of the stationary seat portion 32, the moveable seat portion 36, and the actuator 60 of a second implementation, when the relative positions between stationary seat portion 32 and the moveable seat portion 36 are the neutral position, the left swivel position, and the right swivel position.

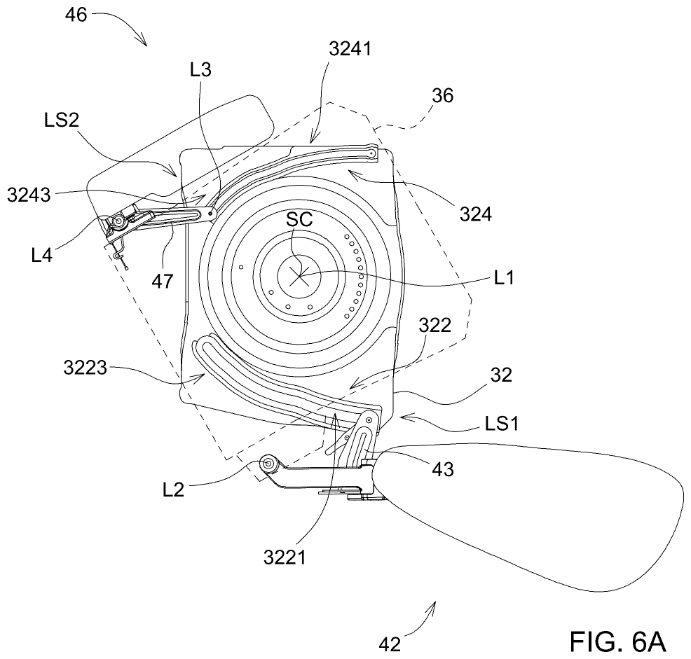

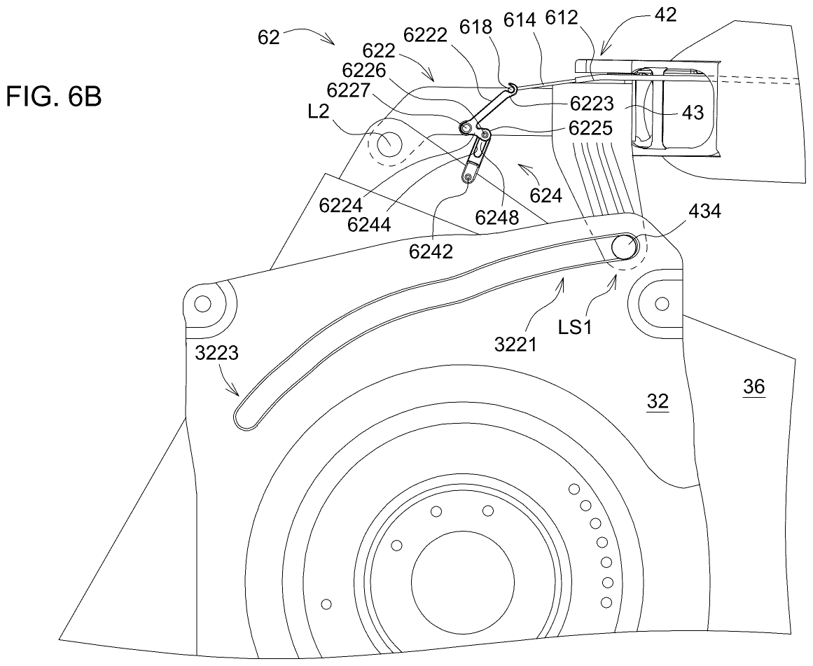

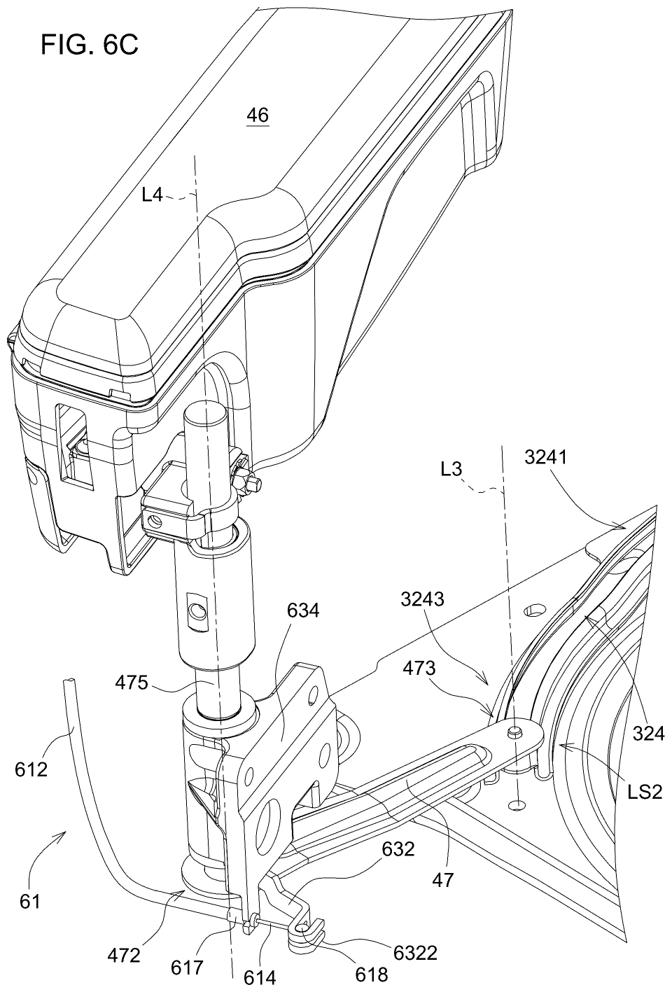

Referring to FIGS. 5A-5C, the first arm 42 is pivotable coupled to the moveable seat portion 36 around a pivot axis L2 and extends forward. The second arm 46 is coupled to the moveable seat portion 36 and extending forward. The second arm 46 is disposed opposite the first arm 42 across the moveable seat portion 36. The swivel axis L1 and the pivot axis L2 are parallel to each other. The stationary seat portion 32 may include a first guide 322 corresponding to the first arm 42 and a second guide 324 corresponding to the second arm 46. The first guide 322 and the second guide 324 are slots shown in FIGS. 5A-7C, but they can be other structures, including but not limited to grooves or tracks. The first guide 322 includes a forward portion 3221 and a rearward portion 3223. The forward portion 3221 is longer than the rearward portion 3223. The first guide 322 is eccentric, and, generally, a radial distance between the forward portion 3221 and the swivel center SC is longer than a radial distance between the rearward portion 3223 and the swivel center SC. A first strut 43 is connected between the first arm 42 and the stationary seat portion 32. The first strut 43 is mounted to the first arm 42 at an end 432 and has a cam 434 at the other end 433 of the first strut 43. Because the first strut 43 provides a constant distance between the end 432 and the end 433 (the cam 434), and the path of the first guide 322, the cam 434 is slidably engaged along the first guide 322 to selectively pivot the first arm 42 inward relative to the moveable seat portion 36 or away from the moveable seat portion 36, in response to the relative motion between the stationary seat portion 32 and the moveable seat portion 36. In other words, there is an angle change between the first arm 42 and the moveable seat portion 36 translated from the relative motion between the stationary seat portion 32 and the moveable seat portion 36. As shown in FIG. 5A, 5B, 5D, which describe the neutral position of the operator seat 30. The cam 434 is positioned at the first neutral position NPL1 of the first guide 322 between the forward portion 3221 and the rearward portion 3223. When the operator seat 30 swivels to the left, as shown in FIG. 6A, 6B, the cam 434, during the rotation between the moveable seat portion 36 and the stationary seat portion 32, dragged by the first strut 43 mounted on the first arm 42, is moved forward to a first left swivel position LS1 at the forward portion 3221. The sliding of the cam 434 along the forward portion 3221 of the first guide 322 pushes the first arm 42 outward and increases the angle between the first arm 42 and the moveable seat portion 36. Therefore, the first arm 42 does not rotate to the left relative to the stationary seat portion 32 in an extent as much as does the moveable seat portion 36, and the arrangement avoid the hit between the first arm 42 and the steering wheel 248. On the contrary, when the operator seat 30 swivels to the right, as shown in FIG. 7A, 7B, the cam 434, during the rotation between the moveable seat portion 36 and the stationary seat portion 32, dragged by the first strut 43 mounted on the first arm 42, is moved rearward to a first right swivel position RS1 at the rearward portion 3223. The sliding of the cam 434 along the rearward portion 3221 of the first guide 322 pulls the first arm 42 inward and decreases the angle between the first arm 42 and the moveable seat portion 36. Therefore, the first arm 42 does not rotate to the right relative to the stationary seat portion 32 in an extent as much as does the moveable seat portion 36, and the arrangement avoid the first arm 42 hitting the cab frame structure 242 and/or the wall 244.

Referring to FIGS. 5A, 50, 6A, 6C, 7A, 7C, the second guide 324 includes a forward portion 3241 and a rearward portion 3243. The forward portion 3241 is longer than the rearward portion 3243. The second guide 324 is eccentric, and, generally, a radial distance between the forward portion 3241 and the swivel center SC is longer than a radial distance between the rearward portion 3243 and the swivel center SC. A second strut 47 is connected between the second arm 46 and the stationary seat portion 32. The second strut 47 is coupled to the second arm 46 at an end 472, with a shaft 475 extending upward from the end 472 of the second strut 47. In this example, the shaft 475 integrally extends from the end 472. The shaft 475 defines the axis L3.

The second arm 46 may be fixed, via a lock such as a saddle lock, at the shaft 475. The second arm 46 may slide along the shaft 457 to change the height of the second arm 46 when the lock is unlocked. The angle between the second strut 47 and the second arm 46 therefore may remain the same when the operator seat 30 swivel to the left or right. An attachment 634 is pivotably coupled to the shaft 475 about the axis L4 (shown in FIGS. 50, 60, 7C) and is mounted on the left side of the moveable seat portion 36 (shown in FIGS. 5A, 6A, 7A but omitted in FIGS. 50, 60, 7C for clarity.) The second strut 47 has a cam 474 at the other end 473 of the second strut 47. Because the second strut 47 provides a constant distance between the end 472 and the end 473 (the cam 474), the path of the second guide 324, and the attachment 634 is coupled to the shaft 475 and moveable together with the moveable seat portion 36 during swivel, the cam 474 is slidably engaged along the second guide 324 to rotate the second strut 47 around the axis L3. The cam 474 is slidably engaged along the second guide 324 in response to the relative motion between the stationary seat portion 32 and the moveable seat portion 36. As shown in FIG. 5A, 5C, which describe the neutral position of the operator seat 30, the cam 474 is positioned at the second neutral position NP2 of the second guide 324 between the forward portion 3241 and the rearward portion 3243. When the operator seat 30 swivels to the left, as shown in FIG. 6A, 6C, the cam 474, during the rotation between the moveable seat portion 36 and the stationary seat portion 32, dragged by the second strut 47 which is pulled by the attachment 634, is moved rearward to a second left swivel position LS2 at the rearward portion 3243. Because the angle between the second arm 46 and the second strut 47 remains the same, as discussed, and the attachment 634 is pivotable on the shaft 475, the angle between the moveable seat portion 36 and the second arm 46 may change, depending on the path of the rearward portion 3243. In the example shown in FIGS. 6A, 6C, the angle between the moveable seat portion 36 (or attachment 634) and the second arm 46 may slightly decrease or remain the same. On the contrary, when the operator seat 30 swivels to the right, as shown in FIG. 7A, 7C, the cam 474, during the rotation between the moveable seat portion 36 and the stationary seat portion 32, dragged by the second strut 47 which is pulled by the attachment 634, is moved forward to a second right swivel position RS2 at the forward portion 3241. Because the angle between the second arm 46 and the second strut 47 remains the same, as discussed, and the attachment 634 is pivotable on the shaft 475, the angle between the moveable seat portion 36 and the second arm 46 may change, depending on the path of the rearward portion 3243. In the example shown in FIGS. 7A, 7C, the angle between the moveable seat portion 36 (or attachment 634) and the second arm 46 increases.

As discussed, there are various types of actuator 60 to actuate the cable 61, included but not limited to a linkage pulling the second end 618 of the core wire 614 of the cable 61 to pivot the holder 50 from the view position to the folded position. The actuator 60 may be installed on different locations at the operator seat 30. In the first implementation, as shown in FIGS. 5B, 5D, 6B, 7B, the actuator 60 includes the linkage 62 coupled between the first arm 42 and the moveable seat portion 36. The linkage 62 includes a bell crank 622 and a connecting link 624. The bell crank 622 includes a first lever 6222, a second lever 6224, and a pivot point 6227 extending the first lever 6222 and the second lever 6224. A distal end 6223 of the first lever 6222 is coupled to the second end 618 of the cable 61. The first end 616 of the cable 61 is coupled to the holder 50, as shown in FIGS. 4F, 4G. The distal end 6225 of the second lever 6224 is coupled to the moveable seat portion 36 via the connecting link 624. The distal end 6225 of the second lever 6224 includes a protrusion 6226 (shown in FIG. 5D). The pivot point 6227 is coupled to the first arm 42 and is pivotable in response to an angle change between the first arm 42 and the moveable seat portion 36 translated from the relative motion between the stationary seat portion 32 and the moveable seat portion 36. The connecting link 624 may have one end (pivot point 6242) pivotably connected to the moveable seat portion 36 and an elongate slot 6244 forming adjacent to the other end of the connecting link 624. The protrusion 6226 at or near the distal end of the second lever 6224 can moveably engage with the elongate slot 6244 in response to the angle change between the first arm 42 and the moveable seat portion 36. It is noted that, in another example (not shown), the pivot point 6227 of the bell crank 622 is pivotably connected to the moveable seat portion 36 with the first lever 6222 and second lever 6224 extending toward the first arm 42, and the pivot point 6242 is pivotably connected to the first arm 42. The protrusion 6226 can also moveably engage with the elongate slot 6244, which is at the opposite end of the pivot point 6242, in response to the angle change between the first arm 42 and the moveable seat portion 36.

FIG. 5B illustrates the original status of the bell crank 622 and the connecting link 624, when the relative position of the stationary seat portion 32 and the moveable seat portion 36 is the neutral position. The protrusion 6226 of the second lever 6224 is at a first location 6246 (e.g., lower edge) of the elongate slot 6244. When the operator seat 30 swivels to the left, as shown in FIG. 6B, the angle between the first arm 42 and the moveable seat portion 36 increases (the first arm 42 is pivoted outward). The connecting link 624 shown in FIG. 6B rotates counterclockwise relative to the moveable seat portion 36. The protrusion 6226 moves from the first location 6246 to the second location 6248 (e.g., upper edge) of the elongate slot 6244, and the bell crank 622 rotates clockwise. As such, the end 618 of the cable 61 is at least not substantially pulled by the linkage 62 of the actuator 60. Therefore, the holder 50 may at least substantially remain at the view position for the operator to watch the electronic device 51, when the operator seat 30 swivels to the left. However, when the operator seat 30 swivels to the right from the neutral position, as shown in FIG. 7B, the angle between the first arm 42 and the moveable seat portion 36 decreases (the first arm 42 is pivoted inward), and the linkage 62 is driven by a movement between the first arm 42 and the moveable seat portion 36 to pivot the holder 50 from the view position to the folded position. The connecting link 624 shown in FIG. 7B may not substantially rotate relative to the moveable seat portion 36. The protrusion 6226 may remain at the first location 6246 (e.g., lower edge). The angle decreasing, between the first arm 42 and the moveable seat portion 36, translated from the relative motion between the stationary seat portion 32 and the moveable seat portion 36 causes the lower edge of the elongate slot 6244 to push the protrusion 6226 of the second lever 6224. Then the bell crank 622 rotates counterclockwise. As such, the end 618 of the cable 61 is pulled by the linkage 62 of the actuator 60. Therefore, the holder 50 is pivoted from the view position to the folded position to clear the upholstery.

In the second implementation, as shown in FIGS. 50, 60, 7C, the actuator 60 includes the linkage 63 coupled between the second arm 46 and the moveable seat portion 36. The linkage 63 includes a third lever 632, which may integrally extend from the bottom of the shaft 475. The end 618 of the core wire 614 of the cable 61 is coupled to a distal end 6322 (a connector) of the third lever 632. The attachment 634 extends a conduit holder to secure a terminal 617 of the conduit 612. FIG. 5C illustrates the original status of linkage 63 (third lever 632 and attachment 634), when the relative position of the stationary seat portion 32 and the moveable seat portion 36 is the neutral position.

In the example shown in FIGS. 6A, 6C, when the operator seat 30 swivels to the left, the angle between the attachment 634 (or the moveable seat portion 36) and the second strut 47 may be substantially the same. The third lever 632 does not pull the second end 618 of the cable 61 in a significant amount to pivot the holder 50 from the view position to the folded position. In the example shown in FIGS. 7A, 7C, when the operator seat 30 swivels to the right, the cam 474 of the second strut 47 moves along the forward portion 3241 of the second guide 324 in response to the relative motion between the stationary seat portion 32 and the moveable seat portion 36. The second strut 47, with the shaft 475 and the third lever 632, rotates relative to the attachment 634 (and the moveable seat portion 36) to pull the cable 61 to pivot the holder 50. Here, the angle between the attachment 634 (and the moveable seat portion 36) and the second strut 47 decreases. The third lever 632 rotates counterclockwise together with the shaft 475 to pull the end 618 of the cable 61 relative to the attachment 634.

Without in any way limiting the scope, interpretation, or application of the claims appearing below, a technical effect of one or more of the example embodiments disclosed herein is to provide an operator seat having a holder to secure an electronic device. The holder can be actuated, in response to a relative motion between a stationary seat portion and a moveable seat portion of the operator seat, to pivot the holder between the view position and the folded position. As such, the holder can be a self-folding electronic device holder. Another technical effect of one or more of the example embodiments disclosed herein is to allow the holder to accommodate full motion of the moveable seat portion to remain free of collisions. As such, the potential damages to upholstery and the holder can be avoided. Another technical effect of one or more of the example embodiments disclosed herein is to provide a breakaway feature for the holder.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “inward,” “outward,” “top,” “bottom,” etc., are used descriptively for the figures, and do not represent limitations on the scope of the disclosure, as defined by the appended claims.

Terms of degree, such as “generally,” “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An operator seat of a work vehicle positioned in a cab, the operator seat comprising:
a stationary seat portion;
a moveable seat portion swivelable relative to the stationary seat portion around a swivel axis;
a holder configured to secure an electronic device;
a support connected to the holder, wherein the holder is pivotable relative to the support between a view position and a folded position; and
an actuator coupled to the holder and actuated, in response to a relative motion between the stationary seat portion and the moveable seat portion, to pivot the holder between the view position and the folded position.

2. The operator seat of claim 1, wherein the actuator includes a linkage and a cable, one end of the cable coupled to the linkage and the other end of the cable coupled to the holder.

3. The operator seat of claim 1, further comprising:
a first arm pivotably coupled to the moveable seat portion around a pivot axis and extending forward; and
wherein the holder is coupled to the first arm.

4. The operator seat of claim 3, wherein the actuator includes a linkage coupled between the first arm and the moveable seat portion.

5. The operator seat of claim 4, wherein the linkage includes a bell crank having a first lever, a second lever, and a pivot point extending the first lever and the second lever, wherein a distal end of the first lever is coupled to one end of a cable, the other end of the cable is coupled to the holder, a distal end of the second lever is coupled to one of the first arm and the moveable seat portion, and the pivot point is coupled to the other one of the first arm and the moveable seat portion and is pivotable in response to an angle change between the first arm and the moveable seat portion translated from the relative motion between the stationary seat portion and the moveable seat portion.

6. The operator seat of claim 5, wherein the linkage includes a connecting link having one end pivotably connected to one of the first arm and the moveable seat portion and an elongate slot forming adjacent to the other end of the connecting link, and the distal end of the second lever includes a protrusion moveably engaging with the elongate slot in response to the angle change.

7. The operator seat of claim 4, further comprising: a strut connected to the first arm at one end and having a cam at the other end;
wherein the stationary seat portion includes a guide along which the cam is slidably engaged to selectively pivot the first arm inward relative to the moveable seat portion or away from the moveable seat portion, in response to the relative motion between the stationary seat portion and the moveable seat portion.

8. The operator seat of claim 7, wherein when the first arm is pivoted inward relative to the moveable seat portion, the linkage is driven by a movement therebetween to pivot the holder from the view position to the folded position.

9. The operator seat of claim 7, wherein the linkage includes a bell crank having a first lever, a second lever, and a pivot point extending the first lever and the second lever and coupled to the first arm, and a connecting link pivotably coupled to the moveable seat portion; and
wherein a distal end of the first lever is coupled to one end of a cable, the other end of the cable is coupled to the holder, a distal end of the second lever is coupled to the connecting link, and the pivot point is pivotable in response to an angle decreasing, between the first arm and the moveable seat portion, translated from the relative motion between the stationary seat portion and the moveable seat portion.

10. The operator seat of claim 7, wherein the swivel axis defines a swivel center on the stationary seat portion, the guide is eccentric and includes a forward portion and a rearward portion, and a radial distance between the forward portion and the swivel center is longer than a radial distance between the rearward portion and the swivel center.

11. The operator seat of claim 1, wherein the support is coupled to the holder via a joint having a torsion spring to provide a breakaway feature between the view position and the folded position.

12. The operator seat of claim 3, further comprising:
a post extending from the first arm and connected to or included by the support; and
a display installed on the post adjacent to the holder.

13. The operator seat of claim 3, wherein the swivel axis and the pivot axis are parallel to each other.

14. The operator seat of claim 1, further comprising:
a first arm coupled to the moveable seat portion around and extending forward; wherein the holder is coupled to the first arm;
a second arm coupled to the moveable seat portion and extending forward; and
wherein the second arm is disposed opposite the first arm across the moveable seat portion.

15. The operator seat of claim 14, further comprising a second strut connected to the second arm at one end and having a cam at the other end; and
wherein the stationary seat portion includes a second guide along which the cam is slidably engaged.

16. The operator seat of claim 15, wherein the second strut is connected to the second arm with a shaft extending from the one end of the second strut, the actuator includes a linkage coupled to the shaft and a cable, one end of the cable coupled to the linkage and the other end of the cable coupled to the holder, and when the cam of the second strut moves along the second guide in response to the relative motion between the stationary seat portion and the moveable seat portion, the second strut with the shaft rotates relative to the moveable seat portion to pull the cable to pivot the holder.

17. The operator seat of claim 16, further comprising an attachment mounted on the moveable seat portion, pivotable coupled to the shaft, and configured to hold a conduit of the cable near the one end of the cable.
